(19) United States
(12) Patent Application Publication
(10) Pub. No.: US 2009/0200520 A1
(43) Pub. Date: Aug. 13, 2009

(54) CONDUCTIVE COMPOSITE MATERIAL

(76) Inventors: Christopher L. Bower, Cambridgeshire (GB); Elizabeth A. Simister, Hertfordshire (GB); Nicholas A. Pightling, Middlesex (GB); Stanley W. Stephenson, III, New York, NY (US)

Correspondence Address: EASTMAN KODAK COMPANY;PATENT LEGAL STAFF, 343 STATE STREET, ROCHESTER, NY, 14650-2201, US

(21) Appl. No.: 12/091,790

(22) PCT Filed: Oct. 9, 2006
(86) PCT No.: PCT/GB2006/003737

§ 371 Date: Apr. 28, 2008

(30) Foreign Application Priority Data
Oct. 29, 2005 (GB) 0522122.1

(51) Int. Cl. H01B 1/02

(52) U.S. Cl. 252/513; 252/500; 252/514

(57) ABSTRACT

A composite comprises conductive particles within a binder matrix, the particles being colloidably unstable within a solution and forming a conductive open network within the binder matrix when dried.

### FIELD OF THE INVENTION

The present application relates to the field of composite materials having conducting particles within a binder matrix. When the particles are arranged in an open, connected network structure a conducting material is created. Low-cost, conductive composites can have application in any area where electrical conductivity is required in films, coatings, paints or inks. One application is in the manufacture of cheap, flexible conductors and electronics for use in areas such as RFID tags and large area displays.

### BACKGROUND OF THE INVENTION

The present application relates to conductive composite materials that consist of conducting particles in a binder matrix. Conductivity is achieved in such systems when a connected conductive pathway is created within the matrix i.e. the percolation threshold is reached. Percolation is a statistical concept that describes the formation of an infinite cluster of connected particles or pathways. The percolation threshold may be defined as the point at which a composite, made up of conducting particles in a binder matrix, becomes conductive. In order to facilitate the production of low-cost electronics it is clearly important that this threshold is as low as possible. One method of achieving this uses elongated, rod-like particles. With these particles a percolating network is achieved at a significantly lower concentration than that required with spherical particles. A further reduction in the percolation threshold has been achieved by making the particles slightly “sticky”.

Currently, transparent electrodes are usually produced by sputter coating indium tin oxide (ITO) on to glass or a flexible substrate, followed by laser patterning. Such an approach can give surface electrical resistivities of the order of 200 Ω/sq. and a transmission of around 80% at 550 nm. However, the process is an expensive one. In addition, ITO coatings such as these however, tend to suffer from brittleness, so that when flexed, the ITO cracks creating breaks in the conduction path.

An alternative approach for creating transparent conductors uses a double layer structure, the lower layer comprising of a fine metal powder (ideally with an average particle size of around 20 nm) in a silica-based matrix coated in a solvent and a silica based upper layer. There is no particular restriction on the method of forming this two-layer structure. Typically the lower layer is spin coated on a transparent substrate and dried in order to remove the solvent. The upper transparent layer is then coated on top, followed by further drying and subsequent baking at elevated temperatures (preferably up to 180° C.). In this approach the film consists of a two-dimensional network of aggregated sub-micron conductive metal particles together with pores consisting of the silica-based material and almost no metal powder, that are essentially transparent to visible light. However, this is a fairly complicated, multi-stage process that includes a time consuming and costly heating step. There is also the problem of ensuring a good electrical connection, since the transparent top layer is essentially an insulator.

Others have focused their efforts on obtaining transparent conductors using just a single layer. The level and type of binder used need to be optimised so that the film strength of the single dried down layer is maintained without detrimentally affecting the percolating network of the conductive metal particles.

US20050062019 describes a transparent conductive film comprising a single layer which contains chainlike aggregates of noble-metal coated silver micro-particles and a binder. The aggregates have an average primary chain length set within the range of 100-500 nm, an average chain thickness set within the range 1-30 nm and an average primary chain length to average thickness ratio set in the range 3-100. However, if the dimensions of these aggregates lie outside the ranges given, it is very much more difficult to form a connected network structure, and as a consequence there is a detrimental effect on the surface resistivity. Hydrazine is added to the stable dispersion that causes the metal-coated silver particles to agglomerate. Such a process involves a large number of different steps which makes it time consuming and relatively costly.

There are a number of companies producing and supplying conductive inks. In the industry, the requirements of the ink needed to produce significant conductivity in a single pass are not well defined or well understood.

Conventional printing methods are still the most cost effective way of manufacturing low cost, high volume, conductive tracks. However when these inks are printed using such methods, multiple passes with registration or post processing steps are required in order to obtain good conductivities.

There is a need for low cost conductive materials for the manufacture of flexible electronics that can have a wide range of potential applications including, but not limited to, RFID and large area displays devices.

### SUMMARY OF THE INVENTION

The invention provides a composite including conductive particles in which the particles are flocculated to form a percolating network. The controlled flocculation of particles, preferably with a high aspect ratio, creates a connected open network. The “connected wires” which make up the network consist of inter-connected particles with thicknesses comparable to the particle diameter. Such an open network can give rise to high transparency conductive materials. The conductivity in these systems occurs when the percolation threshold is reached. This threshold can be significantly reduced by controlling the stability of the colloidal system and also the aspect ratio of the particles. This means that less material is needed to give the same conductivity, thereby reducing the cost.

According to the present invention there is provided a composite comprising conductive particles within a binder matrix, the particles being colloidably unstable in a solution and forming a conductive percolating open network within the matrix when dried.

### ADVANTAGEOUS EFFECT OF THE INVENTION

As the “connected wires” which make up the network consist of interconnected particles with thicknesses comparable to the particle diameter they can be made very thin. This gives rise to high transparency which is advantageous for the production of transparent conductors for display type devices.

Less conductive material is needed to give the same conductivity as those composites formed by a collidably stable system.

### BRIEF DESCRIPTION OF THE DRAWINGS

The invention will now be described with reference to the accompanying drawings in which:

FIG. 1 is a graph illustrating variation of conductivity with increasing volume fraction of particles;

FIG. 2 is an optical microscope image showing the flocculated network of particles in the matrix; and

FIG. 3 is an optical microscope image showing discrete, stabilised, conductive particles in the matrix.

The particles used in the experiments described below are made of 1 μm silver flakes. However, the invention is not limited to silver particles. Other conductive particles, for example, gold, platinum and other metal particles such as copper, iron, nickel, tin, zinc etc may be used. However, when using metals prone to form an oxide steps must be taken to avoid this. The composite material is prepared by mixing the particles at a given volume fraction, together with a dispersant and with a polymeric binder material in such a way that a percolating network of particles is obtained. Each composite mixture is prepared following a set procedure in which the volume fraction of the silver, the dispersant concentration, the order of addition of the materials and the degree of mixing are carefully controlled and defined. The dispersant used here was Surfynol CT131 (a mixture of non-ionic and anionic surfactants) supplied by Air Products and the polymeric material was Type IV regular gelatin. Gelatin has been used here because of its gelation properties. Once the temperature of the gelatin-based silver solution is reduced below a given temperature the gelatin starts to form a gel that holds the structure of the silver particles in place as the layer is dried down.

However, this invention is not limited to using gelatin as the binder and Surfynol CT131 as the dispersant. It will be understood by those skilled in the art that any other suitable materials could be used.

Small quantities of the resulting solution are then applied on to a stretch of gelatin subbed PET. In this experiment, the solution was hand coated on a temperature controlled block, with either an appropriate coating rod or with the blade set to give the required laydown. However it might equally well have been applied using a range of other coating and printing techniques. The wet coating thickness was set to ensure a thickness when dry of 5.3 micron. 0.02% w/w Alkanol XC was added to the final coating solution in order to optimise the uniformity of the layer obtained. The coatings were allowed to dry naturally in air at room temperature and the resulting conductivity was then measured at an approximately constant relative humidity. The optical density was also measured.

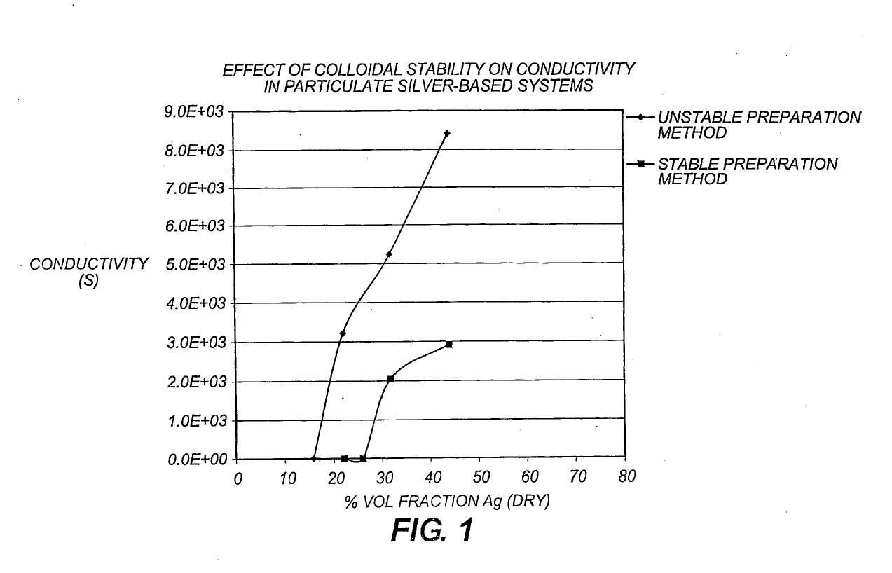

The variation observed in the conductivity for these particulate systems with volume fraction of silver in the dried layer is shown in FIG. 1. Initially when the volume fraction of silver in these dried layers is low, a conductive path does not exist and as a consequence there is little or no conductivity. With increasing volume fraction of silver, the conductivity remains low until the percolation threshold for the system is reached. At this point, there is now a percolating network of particles in the dried layer that allows the current to be conducted. Beyond this point, the conductivity increases rapidly with further increases in the volume fraction of silver in the dried layer and Ohm's law is obeyed.

The order in which the dispersant and the binder are added to the silver has implications on the stability of the colloidal system obtained. If the gelatin (made up into a solution) is added to the silver before the Surfynol CT131 is added, a colloidally stable dispersion of silver particles is obtained (see Example 2) in which the contact between the conductive particles is at a minimum. If, however, the Surfynol CT131 is added to the silver before the gelatin is added a slightly unstable colloidal system is obtained in which the silver particles form a weakly flocculated, open network (see Example 1). Thus, gelatin is a more effective stabiliser of the silver particles than the surfactant CT131.

In forming this network of silver particles, it is possible to dramatically reduce the volume fraction of silver needed to create a conductive pathway through the dried down layer. Thus the percolation threshold for the weakly flocculated (un-stable system) is considerably reduced relative to the value obtained for a colloidally stable system. In the examples given below, the percolation threshold is decreased from ˜26% volume fraction of silver in the dried layer for the colloidally stable system to ˜16% volume fraction of silver for the unstable system. This corresponds to a reduction of around a half in the overall mass of silver required.

The silver particles are arranged in an open percolating network consisting of many thin conductive pathways separated by large areas of binder and dispersant. These non silver areas are essentially transparent to visible light. As a consequence of this and the reduced silver content, the overall optical density of the dried film or coating is reduced significantly i.e. the transmission is high.

Whether or not a colloidally stable or a colloidally unstable system is obtained in these composite mixtures is determined by the order of addition of the CT131 and the gelatin. It is therefore controlled by the effectiveness of the dispersant/binder mixture and in particular, the effectiveness of the material adsorbed at the silver/solution interface in stabilising the silver particles. This effectiveness may in more general terms be affected by the type and concentration of the dispersant and of the binder, and also by whether or not one material adsorbed at the silver interface may be easily displaced by the other. By optimising these factors it is possible to engineer a percolating network with the minimum possible mass of silver in which the connecting “wires” are as fine as possible and where the mesh or network is as open as possible. This minimises the percolation threshold and maximises the transparency.

### EXAMPLE 1

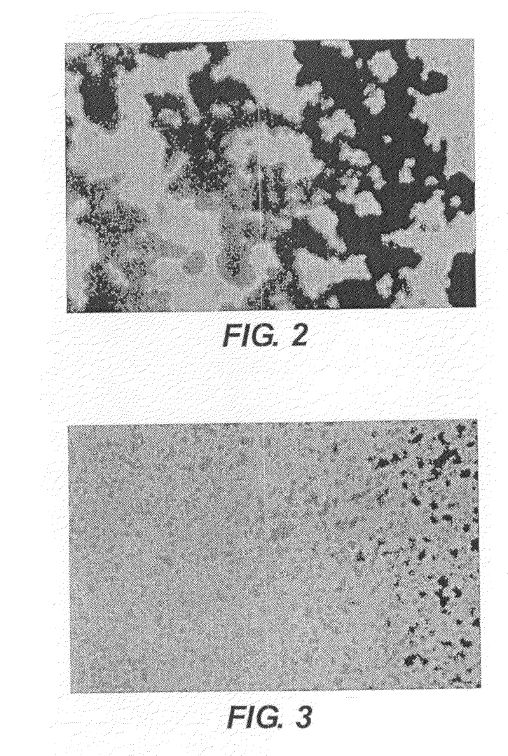

A solution with 7.8% w/w silver flakes (1 μm supplied by the Ferro Corporation), 0.16% w/w Surfynol CT131 and 2.4% w/w Type IV gelatin was prepared. The silver flakes were added to the water, followed by the Surfynol CT131. The mixture was stirred thoroughly with a magnetic stirrer for 15 minutes and was then treated in an ultrasonic bath for 15 minutes. The dried gelatin was added and the resulting solution was heated with stirring to 45° C., until all the gelatin had dissolved. Alkanol XC at 0.02% w/w was finally added to the melt and the solution stirred thoroughly. The mixture was hand coated at a wet thickness of 50 μm to give a final dry layer with 26% v/v silver and a thickness of 5.3 μm. The coatings were allowed to dry in air at room temperature and were then examined under an optical microscope. A typical image, given in FIG. 2, shows that discrete, colloidally stable silver particles are not present in this system. The silver particles (in black) are weakly flocculated and have clearly formed a continuous, open, percolating network throughout the layer. The measured surface electrical resistivity (SER) is 216 ohms/square (conductivity=8.7×10²S). The optical density is 0.19, corresponding to a transmission of 65%. This transmission can be increased, as the system is not optimised.

### EXAMPLE 2

A solution with 7.8% w/w silver flakes, 0.16% w/w Surfynol CT131 and 2.4% w/w Type IV gelatin was prepared. The gelatin was soaked in the required water and was gradually melted with regular stirring in a water bath at 45° C. The silver flakes were added to the solution and the mixture was vigorously stirred for around 15 minutes on a magnetic stirrer and then placed in an ultrasonic bath for around 15 minutes. Surfynol CT131 was added and the mixture was again stirred for around 15 minutes on the magnetic stirrer and then placed in the ultra sonic bath for 15 minutes. Finally, the Alkanol XC was added at 0.02% w/w and the melt stirred thoroughly. The mixture was hand coated at a wet thickness of 50 μm to give a final dry layer with 26% v/v silver and a thickness of 5.3 μm. The coatings were allowed to dry in air at room temperature and were then investigated using the optical microscope (see FIG. 3). In this case, discrete, colloidally stable silver particles are present in the system and there is little or no evidence of any network or conductive pathway. The measured surface electrical resistivity (SER) is 3.3×10⁹ ohms/square (conductivity=5.7×10⁻⁵S).

The invention has been described in detail with reference to preferred embodiments thereof. It will be understood by those skilled in the art that variations and modifications can be effected within the scope of the invention.

1. A composite comprising conductive particles within a binder matrix, the particles being colloidably unstable in a solution and forming a conductive percolating open network within the matrix when dried.

2. A composite comprising conductive particles within a binder matrix, the particles having been flocculated in a solution and forming a conductive percolating open network within the matrix when dried.

3. A composite as claimed in claim 1 or 2 wherein the composite is transparent.

4. A composite as claimed in claim 1 or 2 wherein the particles have a high aspect ratio.

5. A composite as claimed in claim 1 or 2 wherein the particles are metallic.

6. A composite as claimed in claim 1 or 2 wherein the particles are silver particles.

7. A composite as claimed in claim 1 or 2 wherein the particles are gold particles.

8. A composite as claimed in claim 1 or 2 wherein the particles are one of copper, iron, nickel, tin or zinc particles.

9. A display device formed at least in part by a composite as claimed in claim 1 or 2.

10. An RFID tag formed at least in part by a composite as claimed in claim 1 or 2.

11. A flexible electronic circuit or component formed at least in part by a composite as claimed in claim 1 or 2.
